(19) United States
(12) Patent Application Publication
(10) Pub. No.: US 2025/0243588 A1
(43) Pub. Date: Jul. 31, 2025

(54) METHOD OF PREDICTING EXTERNAL CORROSION RISK ON BURIED GAS FLOWLINES

(71) Applicant: SAUDI ARABIAN OIL COMPANY, Dhahran (SA)

(72) Inventors: Muhammad Sohaib Khan, Udhailiyah (SA); Mohammed Saeed Al-Qahtani, Udhailiyah (SA); Tanzeel Ur Rehman, Al Hofuf (SA)

(73) Assignee: SAUDI ARABIAN OIL COMPANY, Dhahran (SA)

(21) Appl. No.: 18/426,924

(22) Filed: Jan. 30, 2024

(51) Int. Cl. C23F 13/22; G06Q 10/20

(52) U.S. Cl. CPC C23F 13/22; G06Q 10/20; C23F 2213/32

(57) ABSTRACT

A method predicts external corrosion risk to facilitate maintenance operation of a pipeline network. The method includes disposing a cathodic protection (CP) system in a vicinity of the pipeline network, obtaining a measurement of a CP current produced by the CP system, comparing the measurement of the CP current to a pre-determined threshold to generate a designated level of the CP current, selectively determining, based on the designated level of the CP current, a conductor surface area of the pipeline, a coating factor of the pipeline network, and an exposure time of the CP current, an external corrosion risk level of the pipeline network, and selectively performing, based on the external corrosion risk level of the pipeline network, the maintenance operation of the pipeline network.

### BACKGROUND

Many industrial applications utilize some underground piping systems where pipelines may be buried in the soil under the earth surface and referred to as buried pipelines. Specifically, a buried pipeline is a pipeline that is underground and in direct contact with soil. For example, oil and gas industry use buried gas flowlines for transporting gas. Buried pipelines, in particular buried gas flowlines, are not accessed routinely and rarely thought about until a problem arises.

### SUMMARY

In general, in one aspect, the invention relates to a method to predict external corrosion risk and facilitate maintenance operation of a pipeline network. The method includes disposing a cathodic protection (CP) system in a vicinity of the pipeline network, wherein the CP system comprises an anode bed comprising a series of electrodes disposed in an electrolytic environment of underground soil where at least a section of the pipeline network is buried, a direct current (DC) power source connected to the anode bed and a buried section of the pipeline network to form a CP current loop where the CP current flows, and a current meter inserted in the CP current loop to generate the measurement of the CP current, obtaining a measurement of a CP current produced by the CP system, comparing the measurement of the CP current to a pre-determined threshold to generate a designated level of the CP current, selectively determining, based on the designated level of the CP current, a conductor surface area of the pipeline, a coating factor of the pipeline network, and an exposure time of the CP current, an external corrosion risk level of the pipeline network, and selectively performing, based on the external corrosion risk level of the pipeline network, the maintenance operation of the pipeline network.

In general, in one aspect, the invention relates to a pipeline corrosion prediction system to predict external corrosion risk and facilitate a maintenance operation of a pipeline network. The pipeline corrosion prediction system includes a computer processor, and memory storing instructions, when executed by the computer processor comprising functionality for obtaining a measurement of a CP current produced by a cathodic protection (CP) system disposed in a vicinity of the pipeline network, wherein the CP system comprises, an anode bed comprising a series of electrodes disposed in an electrolytic environment of underground soil where at least a section of the pipeline network is buried, a direct current (DC) power source connected to the anode bed and a buried section of the pipeline network to form a CP current loop where the CP current flows, and a current meter inserted in the CP current loop to generate the measurement of the CP current, comparing the measurement of the CP current to a pre-determined threshold to generate a designated level of the CP current, selectively determining, based on the designated level of the CP current, a conductor surface area of the pipeline, a coating factor of the pipeline network, and an exposure time of the CP current, an external corrosion risk level of the pipeline network, and selectively facilitating, in response to said comparing and based on the external corrosion risk level of the pipeline network, the maintenance operation of the pipeline network.

pipeline corrosion prediction system an oil and gas facility that includes a pipeline network comprising a buried section disposed in underground soil, and a pipeline corrosion prediction system comprising functionality for obtaining a measurement of a CP current produced by a cathodic protection (CP) system disposed in a vicinity of the pipeline network, comparing the measurement of the CP current to a pre-determined threshold to generate a designated level of the CP current, and selectively facilitating, in response to said comparing and based on the designated level of the CP current, a maintenance operation of the pipeline network.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1D show a system in accordance with one or more embodiments.

FIG. 2 shows a method flowchart in accordance with one or more embodiments.

FIG. 3 shows an example in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a method and system for predicting external corrosion risk for a cathodic-protected (CP) pipeline network such as CP buried gas flowlines. The external corrosion risk is predicted based on a CP system current output, exposure time, conductor surface area and external pipeline coating factor. Accordingly, the external corrosion risk prediction is used to prevent failures, improve system reliability, integrity and more specifically safety of the pipeline network.

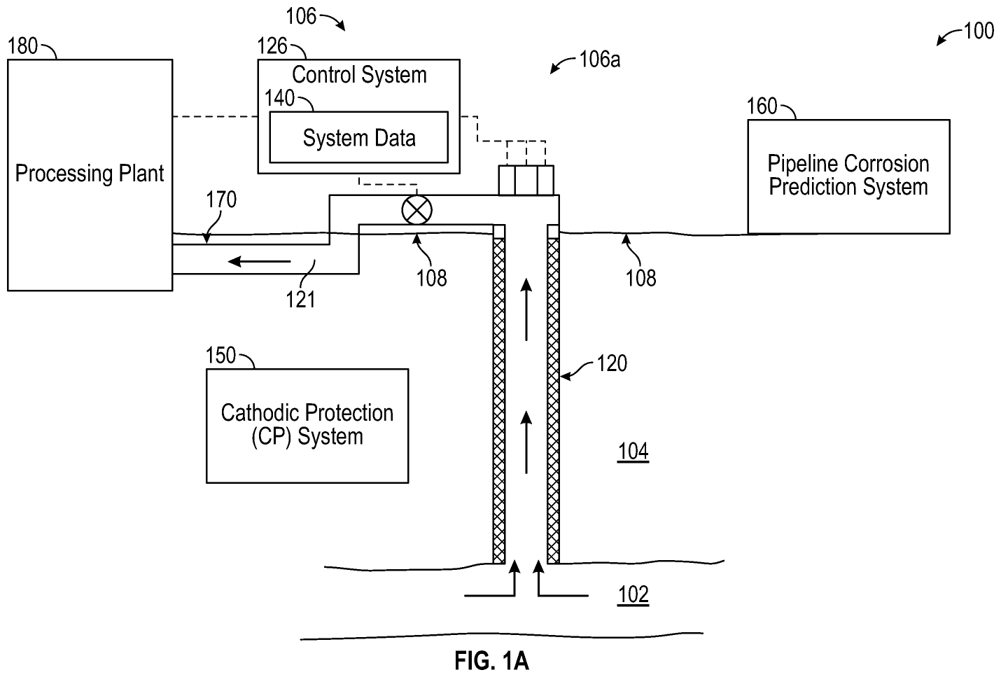

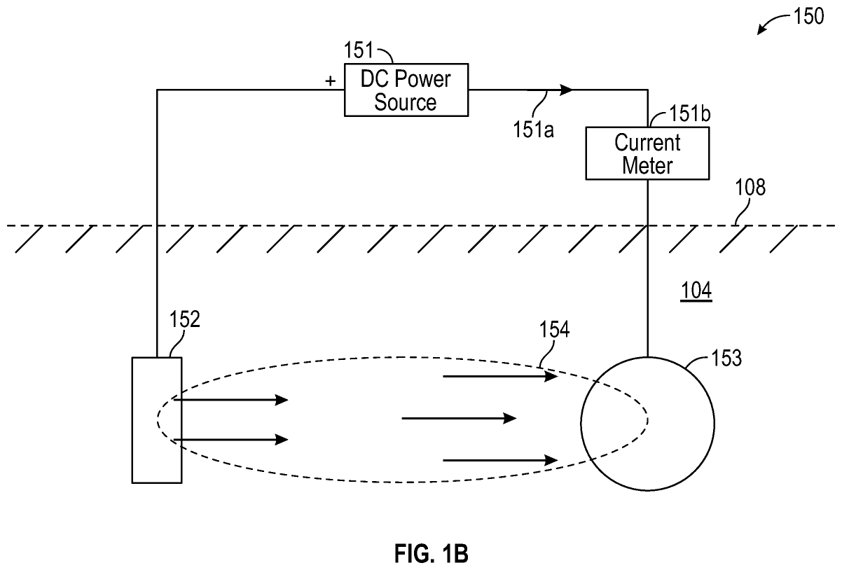

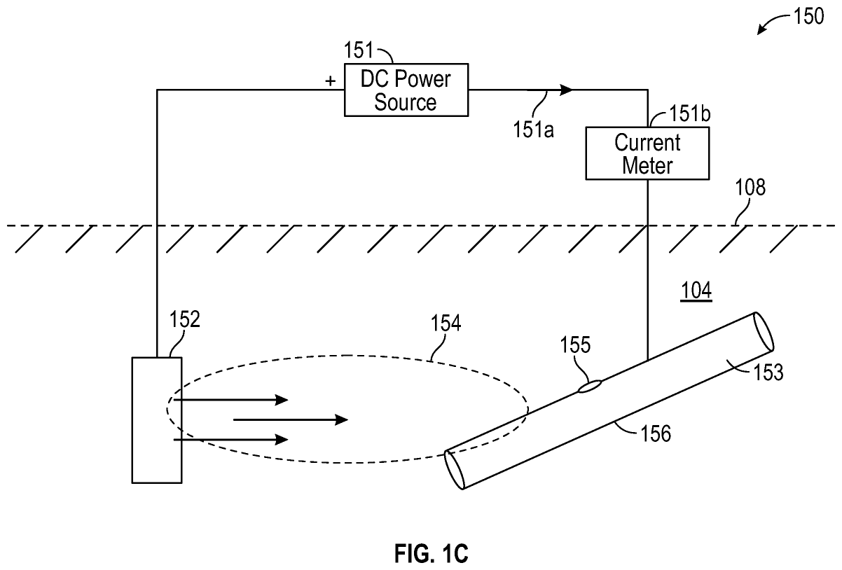

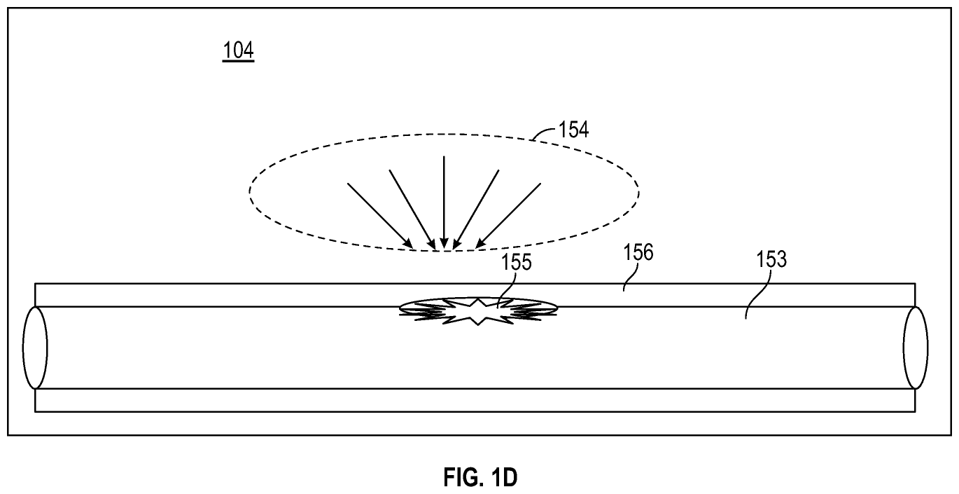

FIG. 1A shows a schematic diagram of an oil and gas facility in accordance with one or more embodiments. As shown in FIG. 1A, the oil and gas facility (100) includes a well system (106) and a processing plant (180). The area where the well system (106) is located is referred to as a wellsite (106a) where hydrocarbons are retrieved from a hydrocarbon reservoir (“reservoir”) (102) located in a subsurface hydrocarbon-bearing formation (“formation”) (104). The hydrocarbon-bearing formation (104) may include a porous or fractured rock formation that resides underground, beneath the earth's surface (“surface”) (108).

As shown in FIG. 1A, the well system (106) includes a wellbore (120) and a control system (126). The control system (126) may control various operations of the well system (106), such as well production operations, well completion operations, well maintenance operations, and reservoir monitoring, assessment and development operations.

The wellbore (120) may include a bored hole that extends from the surface (108) into a target zone of the hydrocarbon-bearing formation (104), such as the reservoir (102). The well system (106) may be part of a production system that further includes a pipeline network (170) for transporting and processing the hydrocarbons, i.e., production (121) from the reservoir (102) to the processing plant (180). The wellbore (120) may have a steel casing and production tubing in contact with soil that can be considered as a buried pipeline having external corrosion risk. For example, the steel casing and/or production tubing may be considered as part of the pipeline network (170).

In one or more embodiments, the processing plant (180) is an industrial process plant such as an oil/petroleum refinery where petroleum (crude oil) is transformed and refined, or other types of chemical processing plants. The processing plant (180) typically includes large, sprawling industrial complexes with extensive piping network running throughout, carrying streams or liquids between large chemical processing units, such as distillation columns. Processing plant facilities require frequent inspection in order to ensure the integrity of the structure, such as any buried pipelines. Although not explicitly shown, similar to the well system (106), the processing plant (180) also includes a control system (126) for controlling various operations of the processing plant (180), such as production operations, maintenance operations, and monitoring, assessment and development operations.

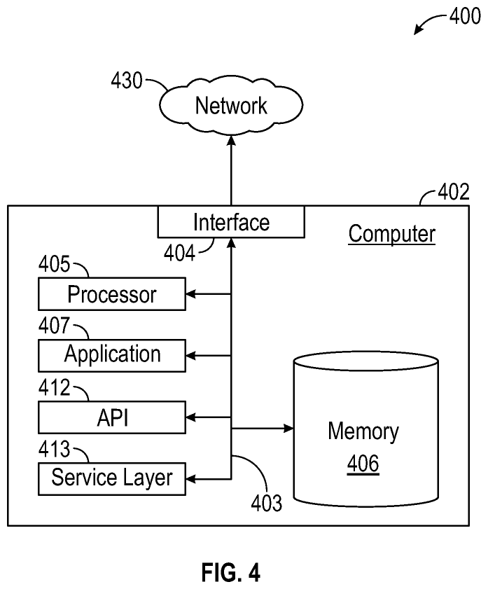

In some embodiments, the control system (126) for the well system (106) and the processing plant (180) includes a computer system that is similar to the computing system (400) described below with regard to FIG. 4 and the accompanying description.

In one or more embodiments, gas producing operations are performed at the oil and gas facility (100) that involve large number of buried flowlines scattered over a huge geographical area that are subject to soil corrosion. Soil corrosion means corrosion of materials by different composition and properties of soil, such as chemical properties, physical properties, and electrochemical properties. Due to the extensive growth of the oil and gas industry, thousands of kilometers of pipelines have been installed, mostly buried underground. The pipelines are susceptible to various damages during service where one of the most common causes of pipeline failure is external corrosion. In general, corrosion of metal in an electrolyte in the soil is basically an electrochemical reaction. The corrosion reaction usually involves anodic areas of the pipeline where oxidation (causing corrosion) takes place, and cathodic areas of the pipeline where a reducing reaction (usually causing no corrosion) occurs. Conventional electric current flows from the anode to the cathode through the electrolyte in the soil, and from the cathode to the anode through the metal. Whether an area is anodic or cathodic can be determined by measuring the electrical potential (i.e., voltage) difference. The anodic/cathodic areas may be on two different metals or on the same metal section of the buried pipeline. Cathodic protection (CP) is a method of reducing voltage differences between anodic and cathodic areas thus mitigating corrosion of buried pipelines. This is achieved by applying an electrical current to the metal structure of a pipeline from an external electrical power source. After applying sufficient current, the entire pipeline metal structure reaches one common potential such that anodic and cathodic sites will not exist across the pipeline. As shown in FIG. 1A, a cathodic protection (CP) system (150) is deployed in the vicinity of the pipeline network (170) to provide CP to the pipeline network (170). In one or more embodiments, at least a portion of the steel casing and/or production tubing of the wellbore (120) is considered as part of the pipeline network (170) and protected against corrosion by the CP system (150). Details of the CP system (150) is described in reference to FIG. 1B below.

FIG. 1B shows a schematic diagram of the CP system (150), depicted in FIG. 1A above, to protect the buried flowlines from soil corrosion. As shown in FIG. 1B, the pipeline (153) is buried under the surface (108) in the formation (104) and corresponds to a portion of the pipeline network (170) or other flowlines of the oil and gas facility (100) depicted in FIG. 1A above. The corrosion protection is applied to the pipeline (153) by connecting the pipeline (153) to the negative terminal of a

DC (direct current) power source (151) of the CP system (150) where an anode bed (152) is connected to the positive terminal of the DC power source (151). An anode bed is a series of electrodes installed in an electrolytic environment of the underground soil to provide cathodic protection (CP) against corrosion by serving as an electrolytic cell component. In this configuration, the corrosion protection is referred to as cathodic protection (CP) and the DC power source (151) is referred to as the CP power source. The DC power source (151) produces an electron flow (151a) from the anode bed (152) to the buried pipeline (153) and a positive ionic current flow (154) from the anode bed (152) through the electrolytic environment (soil) to the pipeline (153). The positive ionic current flow (154) is referred to as the CP current that eliminates or minimizes the anodic and cathodic areas on the protected pipeline (153) which in turn minimizes the corrosion. The magnitude (i.e., numerical value) of the positive ionic current flow (154) equals the magnitude of the electron flow (151a). A current meter (151b) is connected in series with the DC power source (151) to measure the magnitude of the electron flow (151a), which in turn represents the magnitude of the positive ionic current flow (154), i.e., the CP current.

In some embodiments, the entire pipeline network (170) is cathodic-protected by one or more CP power sources, e.g., DC power source (151). In some embodiments, multiple CP power sources are used collectively to provide cathodic protection for the pipeline network (170) where each CP power source is connected to a corresponding anode bed and a corresponding section of the pipeline network (170) to provide cathodic protection for the corresponding section of the pipeline network (170). For example, the protected pipeline length may be 5 Km-10 Km in length and 4″-10″ in diameter. One CP system may be used for protecting one pipeline or two pipelines. In general, if the CP system is used for one pipeline then depending on the length/coating of pipeline and soil resistivity, the output of CP system may be 50 Volts and 50 Amperes. The anode bed is usually 60 meters deep from the ground surface. In case one CP system is used for protecting two pipelines then the output of CP system may be 100 Volts and 100 Amperes with the depth of anode bed approximately 60 meters. Anode dimensions vary dependent on the anode material and type, e.g., ICCP HSCI anode with 95 mm cylindrical diameter and 2133 mm in length.

FIG. 1C shows a schematic diagram of the CP system (150) where the outer surface of the pipeline (153) is coated with epoxy coating (156) or other suitable material as the first line of defense against soil corrosion. The coating (156) may contain defects during application/installation or due to coating deterioration, such as the coating defect (155). To fortify the first line of defense, the CP is applied to protect the coated pipeline (153) where defects in coating may exist. These coating defects (155) may further lead to disbondment (i.e., loss of adhesion) of coating shown in FIG. 1D and cause corrosion even on cathodic-protected pipelines.

Although the CP system provides corrosion protection for the required structure, it could have detrimental effects on the nearby structures due to stray current arising from nearby CP power sources. The stray current is defined as current flowing through paths other than the intended circuit. The stray current flowing through the soil is picked up by foreign buried line near the protected line. The stray current travel through the foreign line and into ground soil may cause corrosion in the foreign line. The stray current can be fatal and resulting in costly failures as well as creating health, safety & environment (HSE) risks.

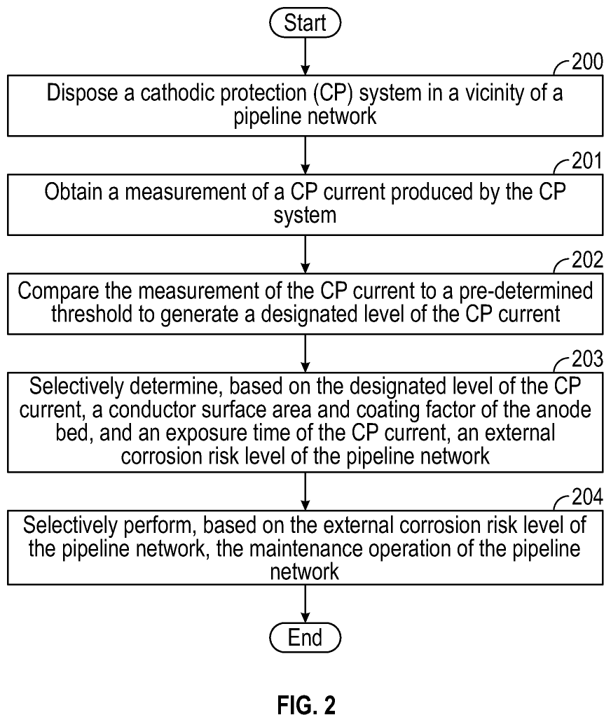

Returning to the discussion of FIG. 1A, in some embodiments, the oil and gas facility (100) includes a pipeline corrosion prediction system (160). For example, the pipeline corrosion prediction system (160) may include hardware and/or software with functionality for predicting the external corrosion risk level of the pipeline network (170) and facilitating corresponding maintenance operations. For example, the pipeline corrosion prediction system (160) may obtain input data from the CP system (150), such as CP current measurements, anode bed conductor surface area, exposure time, etc. for analysis to generate various levels of external corrosion threat of the pipeline network (170). In one or more embodiments, the CP system (150) and the pipeline corrosion prediction system (160) include data communication modules to transmit data between them. In one or more embodiments, the pipeline corrosion prediction system (160) performs these functionalities using the method described in reference to FIG. 2 below. In some embodiments, at least a portion of the pipeline corrosion prediction system (160) is integrated into the CP system (150) and/or the control system (126). In some embodiments, the pipeline corrosion prediction system (160) may include a computer system that is similar to the computing system (400) described below with regard to FIG. 4 and the accompanying description.

FIG. 2 shows a method flowchart in accordance with one or more embodiments disclosed herein. One or more of the steps in FIG. 2 may be performed by the components of the oil and gas facility (100) and the pipeline corrosion prediction system (160), discussed above in reference to FIGS. 1A-1D. In one or more embodiments, one or more of the steps shown in FIG. 2 may be omitted, repeated, and/or performed in a different order than the order shown in FIG. 2. Accordingly, the scope of the disclosure should not be considered limited to the specific arrangement of steps shown in FIG. 2.

Initially in Step 200, a cathodic protection (CP) system is disposed in a vicinity of the pipeline network. In one or embodiments, the CP system is disposed by embedding an anode bed of a series of electrodes in an electrolytic environment of underground soil where at least a section of the pipeline network is buried, connecting a direct current (DC) power source to the anode bed and a buried section of the pipeline network to form a CP current loop where the CP current flows, and inserting a current meter in the CP current loop to monitor the CP current.

In Step 201, a measurement of the CP current produced by the CP system is obtained using the current meter.

In Step 202, the measurement of the CP current is compared to a pre-determined threshold to generate a designated level of the CP current. In one or more embodiments, the pre-determined threshold includes an upper set value and a lower set value. The CP current is designated as a high level based on the measurement of the CP current exceeding the upper set value of the pre-determined threshold. The CP current is designated as a medium level based on the measurement of the CP current being in-between the upper set value and the lower set value of the pre-determined threshold, The CP current is designated as a low level based on the measurement of the CP current being less than the lower set value of the pre-determined threshold,

In Step 203, an external corrosion risk level of the pipeline network is selectively determined based on the designated level of the CP current, a conductor surface area of the pipeline, a coating factor of the pipeline network, and an exposure time of the CP current. For the case of the low level CP current, the external corrosion risk level of the pipeline network is determined as either high threat or medium threat based on the conductor surface area of the pipeline and the coating factor of the pipeline network, regardless of the exposure time of the CP current. For the case of the medium level CP current and under the condition that the exposure time of the CP current exceeds a pre-determined exposure time threshold, the external corrosion risk level of the pipeline network is also determined as either high threat or medium threat based on the conductor surface area of the pipeline and the coating factor of the pipeline network. For the case of the medium level CP current and under the condition that the exposure time of the CP current is less than the pre-determined exposure time threshold, the external corrosion risk level of the pipeline network is determined as low threat. For the case of the high level CP current, the external corrosion risk level of the pipeline network may not be determined because no maintenance operation of the pipeline network is performed with such sufficient protection by the CP current.

In Step 204, the maintenance operation of the pipeline network is selectively performed based on the external corrosion risk level of the pipeline network. For the risk level of high external corrosion threat, a high external corrosion threat maintenance operation is selected to be performed for the pipeline network. For the risk level of medium external corrosion threat, a medium external corrosion threat maintenance operation is selected to be performed for the pipeline network. For the risk level of low external corrosion threat, a low external corrosion threat maintenance operation is selected to be performed for the pipeline network. In one or more embodiments, the maintenance operation of the pipeline network is withheld in response to designating the CP current as the high level where the external corrosion risk level of the pipeline network may not be determined.

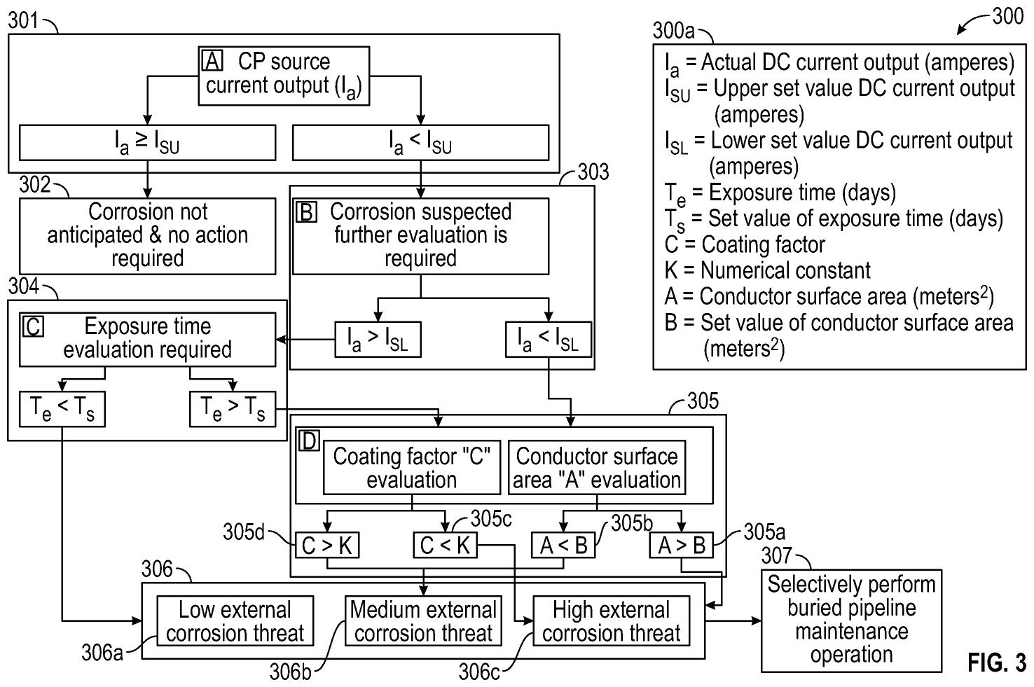

An example of the method flowchart depicted in FIG. 2 above is described in reference to FIG. 3 below.

FIG. 3 shows an implementation example in accordance with one or more embodiments. Specifically, FIG. 3 shows an example workflow (300) for external corrosion prediction of buried pipeline according to the legend (300a). One or more of the workflow steps in FIG. 3 may be performed by the components of the oil and gas facility (100) and the pipeline corrosion prediction system (160), discussed above in reference to FIGS. 1A-1D. In one or more embodiments, one or more of the steps shown in FIG. 3 may be omitted, repeated, and/or performed in a different order than the order shown in FIG. 3. Accordingly, the scope of the disclosure should not be considered limited to the specific arrangement of steps shown in FIG. 3.

Initially in Step 301, the actual DC current (i.e., CP current) of the CP power source is measured. If the measured current value (Iₐ) is greater than an upper set value (I_{SU}), the workflow proceeds to Step 302. If the measured current value (Iₐ) is less than the upper set value (I_{SU}), the workflow proceeds to Step 303. The upper set value (I_{SU}) is a pre-determined non-zero numerical value that is selected based on field experiments. For example, selection may depend on maximum current requirement to attain protection level.

In Step 302, it is determined that no corrosion of the buried pipeline is anticipated and no physical maintenance action is performed.

In Step 303, the measured current value (Iₐ) is further evaluated with respect to a lower set value (I_{SL}). If the measured current value (Iₐ) is greater than the lower set value (I_{SL}), the workflow proceeds to Step 304. If the measured current value (Iₐ) is less than the lower set value (I_{SL}), the workflow proceeds to Step 305. The lower set value (I_{SL}) is a pre-determined non-zero numerical value that is selected based on field experiments as the minimum current requirement to attain optimum protection in-relation to electrolyte electrical resistivity, cathode surface area and coating condition.

In Step 304, the buried pipeline corrosion threat is evaluated based on the exposure time (Tₑ), which is the total time period during which the pipeline is exposed to the CP current having the measured current value (Iₐ). The exposure time (Tₑ) is compared with a set value of exposure time (Tₛ). If the exposure time (Tₑ) is less than the set value of exposure time (Tₛ), the workflow proceeds to Step 307 and mark the corrosion threat as low external corrosion threat (306a). If the exposure time (Tₑ) is greater than the set value of exposure time (Tₛ), the workflow proceeds to Step 305. The set value of exposure time (Tₛ) is a pre-determined numerical value that is selected based on field experiments. The exposure time duration may be calculated based on field experiments as the time period during which zero or minimum corrosion occurred within an acceptable extent.

In Step 305, the conductor surface area of the pipeline (A) and the coating factor (C) of the pipeline network are evaluated before the workflow proceeds to Step 306 to determine the buried pipeline corrosion threat. Specifically, the evaluation in Step 305 is under the first condition of insufficient CP current (i.e., the measured current value (Iₐ) being less than the lower set value (I_{SL})) or the second condition of sufficient CP current but with prolonged exposure time (i.e., the exposure time (Tₑ) being greater than the set value of exposure time (Tₛ)).

If the conductor surface area of the pipeline (A) is larger than the set value of conductor surface area (B), i.e., condition 305a, the workflow proceeds to Step 306 to determine the buried pipeline corrosion threat as high external corrosion threat (306c) where immediate actions are required. The set value of conductor surface area (B) is a pre-determined numerical value that is determined based on the field experiments. For example, the value may be calculated based on the pipeline length and diameter with ±15% accuracy.

If the conductor surface area of the pipeline (A) is less than the set value of conductor surface area (B), i.e., condition 305b, the workflow proceeds to Step 306 to determine the buried pipeline corrosion threat as medium external corrosion threat (306b).

If the coating factor (C) of the pipeline network is less than the set value of the coating factor (K) (constant), i.e., condition 305c, the workflow proceeds to Step 306 to determine the buried pipeline corrosion threat as high external corrosion threat (306c) where immediate actions are required. The set value of coating factor (K) is a pre-determined numerical value that is selected based on the type of coating, e.g., fusion bonded epoxy coating, tape wrap, etc.

If the coating factor (C) of the pipeline network is greater than the set value of the coating factor (K) (constant), i.e., condition 305d, the workflow proceeds to Step 306 to determine the buried pipeline corrosion threat as medium external corrosion threat (306b).

In Step 307, a buried pipeline maintenance operation is selectively performed based on the buried pipeline corrosion threat identified in Step 306. The example maintenance operation includes replacing or repairing a section of the pipeline with excessive external corrosion, tightening any loose terminal connections of the CP system, cleaning any rusty cable joints, repairing cable insulation damages, upgrading rectifier capacity, replacing rectifier burned shunts, refilling rectifier oil and replacing contaminated oil.

As noted above, in some embodiments, multiple CP power sources are used collectively to provide cathodic protection for the pipeline network where each CP power source is connected to a corresponding anode bed and a corresponding section of the pipeline network. In such embodiments, the workflow (300) is performed for each individual section of the pipeline network. For example, the exposure time, coating factor, and conductor surface area referred to in the description above correspond to the individual section of the pipeline.

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112 (f) for any limitations of any of the claims herein, except for those in which the claim expressly uses the words “means for” or “step for” together with an associated function.

What is claimed:

1. A method to predict external corrosion risk and facilitate maintenance operation of a pipeline network, comprising:
disposing a cathodic protection (CP) system in a vicinity of the pipeline network, wherein the CP system comprises:
an anode bed comprising a series of electrodes disposed in an electrolytic environment of underground soil where at least a section of the pipeline network is buried;
a direct current (DC) power source connected to the anode bed and a buried section of the pipeline network to form a CP current loop where the CP current flows; and
a current meter inserted in the CP current loop to generate the measurement of the CP current;
obtaining a measurement of a CP current produced by the CP system;
comparing the measurement of the CP current to a pre-determined threshold to generate a designated level of the CP current;
selectively determining, based on the designated level of the CP current, a conductor surface area of the pipeline, a coating factor of the pipeline network, and an exposure time of the CP current, an external corrosion risk level of the pipeline network; and
selectively performing, based on the external corrosion risk level of the pipeline network, the maintenance operation of the pipeline network.

2. The method of claim 1, wherein said comparing the measurement of the CP current to the pre-determined threshold to generate the designated level of the CP current comprises:
designating the CP current as a high level based on the measurement of the CP current exceeding an upper set value of the pre-determined threshold; and
withholding, in response to designating the CP current as the high level, the maintenance operation of the pipeline network.

3. The method of claim 1, wherein said comparing the measurement of the CP current to the pre-determined threshold to generate the designated level of the CP current comprises:
designating the CP current as a medium level based on the measurement of the CP current being in-between the upper set value and a lower set value of the pre-determined threshold,
wherein the external corrosion risk level of the pipeline network is determined, in response to designating the CP current as the medium level, based on the conductor surface area of the pipeline and the coating factor of the pipeline network.

4. The method of claim 3, wherein said selectively determining the external corrosion risk level of the pipeline network comprises:
comparing the conductor surface area of the pipeline to a pre-determined surface area threshold; and
comparing, the coating factor of the pipeline network to a pre-determined coating factor threshold,
wherein the external corrosion risk level of the pipeline network is determined as a high external corrosion threat based on the conductor surface area of the pipeline exceeding the pre-determined surface area threshold or based on the coating factor of the pipeline network being less than the pre-determined coating factor threshold, and
wherein a high external corrosion threat maintenance operation is selected to be performed for the pipeline network.

5. The method of claim 3, wherein said selectively determining the external corrosion risk level of the pipeline network comprises:
comparing the conductor surface area of the pipeline to a pre-determined surface area threshold; and
comparing, the coating factor of the pipeline network to a pre-determined coating factor threshold,
wherein the external corrosion risk level of the pipeline network is determined as a medium external corrosion threat based on the conductor surface area of the pipeline being less than the pre-determined surface area threshold or based on the coating factor of the pipeline network exceeding the pre-determined coating factor threshold, and
wherein a medium external corrosion threat maintenance operation is selected to be performed for the pipeline network.

6. The method of claim 1, wherein said comparing the measurement of the CP current to the pre-determined threshold to generate the designated level of the CP current comprises:
designating the CP current as a low level based on the measurement of the CP current being less than a lower set value of the pre-determined threshold,
wherein the external corrosion risk level of the pipeline network is determined, in response to designating the CP current as low level, based on the conductor surface area of the pipeline, the coating factor of the pipeline network, and the exposure time of the CP current.

7. The method of claim 6, wherein said selectively determining the external corrosion risk level of the pipeline network comprises:
comparing the exposure time to a pre-determined time threshold;
in response to the exposure time exceeding the pre-determined time threshold, comparing the conductor surface area of the pipeline to a pre-determined surface area threshold, and comparing the coating factor of the pipeline network to a pre-determined coating factor threshold,
wherein the external corrosion risk level of the pipeline network is determined as a high external corrosion threat based on the conductor surface area of the pipeline exceeding the pre-determined surface area threshold or based on the coating factor of the pipeline network being less than the pre-determined coating factor threshold, and
wherein a high external corrosion threat maintenance operation is selected to be performed for the pipeline network.

8. The method of claim 6, wherein said selectively determining the external corrosion risk level of the pipeline network comprises:
comparing the exposure time to a pre-determined time threshold;
in response to the exposure time exceeding the pre-determined time threshold, comparing the conductor surface area of the pipeline to a pre-determined surface area threshold, and comparing, the coating factor of the pipeline network to a pre-determined coating factor threshold,
wherein the external corrosion risk level of the pipeline network is determined as a medium external corrosion threat based on the conductor surface area of the pipeline being less than the pre-determined surface area threshold or based on the coating factor of the pipeline network exceeding the pre-determined coating factor threshold, and
wherein a medium external corrosion threat maintenance operation is selected to be performed for the pipeline network.

9. The method of claim 6, wherein said selectively determining the external corrosion risk level of the pipeline network comprises:
comparing the exposure time to a pre-determined time threshold,
wherein the external corrosion risk level of the pipeline network is determined as a low external corrosion threat based on the exposure time being less than the pre-determined time threshold, and
wherein a low external corrosion threat maintenance operation is selected to be performed for the pipeline network.

10. A pipeline corrosion prediction system to predict external corrosion risk and facilitate a maintenance operation of a pipeline network, comprising:
a computer processor; and
memory storing instructions, when executed by the computer processor comprising functionality for:
obtaining a measurement of a CP current produced by a cathodic protection (CP) system disposed in a vicinity of the pipeline network, wherein the CP system comprises:
an anode bed comprising a series of electrodes disposed in an electrolytic environment of underground soil where at least a section of the pipeline network is buried;
a direct current (DC) power source connected to the anode bed and a buried section of the pipeline network to form a CP current loop where the CP current flows; and
a current meter inserted in the CP current loop to generate the measurement of the CP current;
comparing the measurement of the CP current to a pre-determined threshold to generate a designated level of the CP current;
selectively determining, based on the designated level of the CP current, a conductor surface area of the pipeline, a coating factor of the pipeline network, and an exposure time of the CP current, an external corrosion risk level of the pipeline network; and
selectively facilitating, in response to said comparing and based on the external corrosion risk level of the pipeline network, the maintenance operation of the pipeline network.

11. The pipeline corrosion prediction system of claim 10, wherein said comparing the measurement of the CP current to the pre-determined threshold to generate the designated level of the CP current comprises:
designating the CP current as a high level based on the measurement of the CP current exceeding an upper set value of the pre-determined threshold; and
withholding, in response to designating the CP current as the high level, the maintenance operation of the pipeline network.

12. The pipeline corrosion prediction system of claim 10, wherein said comparing the measurement of the CP current to the pre-determined threshold to generate the designated level of the CP current comprises:
designating the CP current as a medium level based on the measurement of the CP current being in-between the upper set value and a lower set value of the pre-determined threshold,
wherein the external corrosion risk level of the pipeline network is determined, in response to designating the CP current as the medium level, based on the conductor surface area of the pipeline and the coating factor of the pipeline network.

13. The pipeline corrosion prediction system of claim 12, wherein said selectively determining the external corrosion risk level of the pipeline network comprises:
comparing the conductor surface area of the pipeline to a pre-determined surface area threshold; and
comparing, the coating factor of the pipeline network to a pre-determined coating factor threshold,
wherein the external corrosion risk level of the pipeline network is determined as a high external corrosion threat based on the conductor surface area of the pipeline exceeding the pre-determined surface area threshold or based on the coating factor of the pipeline network being less than the pre-determined coating factor threshold, and
wherein a high external corrosion threat maintenance operation is selected to be performed for the pipeline network.

14. The pipeline corrosion prediction system of claim 12, wherein said selectively determining the external corrosion risk level of the pipeline network comprises:
comparing the conductor surface area of the pipeline to a pre-determined surface area threshold; and
comparing, the coating factor of the pipeline network bed to a pre-determined coating factor threshold,
wherein the external corrosion risk level of the pipeline network is determined as a medium external corrosion threat based on the conductor surface area of the pipeline being less than the pre-determined surface area threshold or based on the coating factor of the pipeline network exceeding the pre-determined coating factor threshold, and
wherein a medium external corrosion threat maintenance operation is selected to be performed for the pipeline network.

15. The pipeline corrosion prediction system of claim 10, wherein said comparing the measurement of the CP current to the pre-determined threshold to generate the designated level of the CP current comprises:
designating the CP current as a low level based on the measurement of the CP current being less than a lower set value of the pre-determined threshold,
wherein the external corrosion risk level of the pipeline network is determined, in response to designating the CP current as low level, based on the conductor surface area of the pipeline and the coating factor of the pipeline network and the exposure time of the CP current.

16. The pipeline corrosion prediction system of claim 15, wherein said selectively determining the external corrosion risk level of the pipeline network comprises:
comparing the exposure time to a pre-determined time threshold;
in response to the exposure time exceeding the pre-determined time threshold, comparing the conductor surface area of the pipeline to a pre-determined surface area threshold, and comparing the coating factor of the pipeline network to a pre-determined coating factor threshold,
wherein the external corrosion risk level of the pipeline network is determined as a high external corrosion threat based on the conductor surface area of the pipeline exceeding the pre-determined surface area threshold or based on the coating factor of the pipeline network being less than the pre-determined coating factor threshold, and
wherein a high external corrosion threat maintenance operation is selected to be performed for the pipeline network.

17. The pipeline corrosion prediction system of claim 15, wherein said selectively determining the external corrosion risk level of the pipeline network comprises:
comparing the exposure time to a pre-determined time threshold;
in response to the exposure time exceeding the pre-determined time threshold, comparing the conductor surface area of the pipeline to a pre-determined surface area threshold, and comparing the coating factor of the pipeline network to a pre-determined coating factor threshold,
wherein the external corrosion risk level of the pipeline network is determined as a medium external corrosion threat based on the conductor surface area of the pipeline being less than the pre-determined surface area threshold or based on the coating factor of the pipeline network exceeding the pre-determined coating factor threshold, and
wherein a medium external corrosion threat maintenance operation is selected to be performed for the pipeline network.

18. The pipeline corrosion prediction system of claim 15, wherein said selectively determining the external corrosion risk level of the pipeline network comprises:
comparing the exposure time to a pre-determined time threshold,
wherein the external corrosion risk level of the pipeline network is determined as a low external corrosion threat based on the exposure time being less than the pre-determined time threshold, and
wherein a low external corrosion threat maintenance operation is selected to be performed for the pipeline network.

19. An oil and gas facility, comprising:
a pipeline network comprising a buried section disposed in underground soil; and
a pipeline corrosion prediction system comprising functionality for:
obtaining a measurement of a CP current produced by a cathodic protection (CP) system disposed in a vicinity of the pipeline network;
comparing the measurement of the CP current to a pre-determined threshold to generate a designated level of the CP current; and
selectively facilitating, in response to said comparing and based on the designated level of the CP current, a maintenance operation of the pipeline network.

20. The oil and gas facility of claim 19, wherein the CP system comprises:
an anode bed comprising a series of electrodes disposed in an electrolytic environment of underground soil where at least a section of the pipeline network is buried;
a direct current (DC) power source connected to the anode bed and a buried section of the pipeline network to form a CP current loop where the CP current flows; and
a current meter inserted in the CP current loop to generate the measurement of the CP current.
